(19) United States
(12) Patent Application Publication
(10) Pub. No.: US 2024/0239106 A1
(43) Pub. Date: Jul. 18, 2024

(54) PRINTING DEVICE AND EXTRACTION DEVICE FOR EXTRACTING PRINTING MIST

(71) Applicant: Dekron GmbH, Kelkheim (DE)

(72) Inventors: Klaus EICH, Hofheim (DE); Thomas SPELLUCCI, Eschborn (DE); Tobias KUNISCHEWSKI, Frankfurt (DE)

(21) Appl. No.: 18/413,820

(22) Filed: Jan. 16, 2024

(30) Foreign Application Priority Data
Jan. 17, 2023 (DE) 10 2023 101 051.4

(51) Int. Cl. B41J 2/17; B41J 3/407

(52) U.S. Cl. CPC B41J 2/1714; B41J 3/40733

(57) ABSTRACT

The disclosure relates to a printing device for printing containers with at least one printing plane. At least one print head for applying ink to the container and at least one extraction device associated with the print head for extracting printing mist are arranged in each printing plane along an outer circumference of a free space which is designed to receive a container to be printed. The at least one print head and the at least one extraction device associated therewith are at a spacing from one another along the outer circumference. The disclosure further relates to an extraction device for extracting printing mist for use in the printing device, wherein the extraction device comprises an extraction tube, an extraction nozzle, and a connection device.

### CROSS REFERENCE TO RELATED APPLICATION

The present application claims priority to German Patent Application No. 10 2023 101 051.4 filed on Jan. 17, 2023. The entire contents of the above-listed application are hereby incorporated by reference for all purposes.

### TECHNICAL FIELD

The disclosure relates to a printing device and an extraction device for extracting printing mist.

### BACKGROUND

Printing devices are known for printing containers such as bottles, cans, or the like, which are also referred to as direct printing devices, for example. The printing device can comprise at least one electronically or digitally controllable print head with which the containers can be printed during a printing process. During the printing process, the print head can be in a defined relative position to a print area on the outside of the container and can apply printing fluid in a desired pattern in the print area. The applied printing fluid can then be hardened, for example, by means of UV drying. Several print heads each with different inks can also be provided.

### SUMMARY

Printing mist can arise during the printing process—for example, due to droplets breaking off when the printing fluid is ejected from the nozzles of the print head and/or when the print fluid hits the print area of the container. The printing mist can spread uncontrollably in the surrounding air and can be deposited on parts of the printing device, where it can lead to contamination and damage. During the UV drying after the application of the printing fluid to at least a part of the print area, it can happen that some of deposited printing mist can also be hardened.

EP 2 250 026 A1 discloses a printing device with several printing positions which each comprise a container plate and a plunger for fixing the container on the container plate. Each printing position is associated with a sleeve-like enclosure which, in a closed state, completely encloses the container and also receives and encloses the print heads, by means of which the container is to be printed, and fixing devices for hardening the printing ink. An extraction device is connected to the cover of the enclosure by means of several extraction tubes. The enclosure comprises a slot-shaped opening at the lower edge so that air can flow to allow the printing mist to be extracted.

### Object

The object of the disclosure is to provide a printing device and an extraction device for extracting printing mist which can enable efficient extraction of printing mist with minimal contamination of the extraction device.

### Achievement

The object is achieved by the printing device and the extraction device for extracting printing mist.

The printing device according to the disclosure for printing containers comprises at least one printing plane, wherein at least one print head for applying ink to the container and at least one extraction device associated with the print head for extracting printing mist are arranged in each printing plane along an outer circumference of a free space which is designed to receive a container to be printed. The at least one print head and the at least one extraction device associated therewith are spaced from one another along the outer circumference.

The containers can comprise glass, PET bottles or bottles comprising fibers (for example, manufactured by using fiber-containing pulp), cans (cans comprising glass, PET, metal cans, or fibers (for example, manufactured using fiber-containing pulp)), and the like.

The outer circumference can describe a lateral surface along a height of the free space.

Printing mist can occur when printing ink is dispensed using the print nozzles of the print head—for example, due to drops/droplets breaking off and/or when the printing ink hits the container to be printed.

For each extraction device, a negative pressure can be between 10 mbar to 70 mbar (the range limits can be included). The negative pressure can be controllable and/or regulatable. The negative pressure can be specified in relation to a prevailing ambient pressure of an environment in which the printing device can be operated.

A first spacing of a first print head to a first associated extraction device can have a first value, and a second spacing of a second print head to a second associated extraction device can have a second value. The first and second values can be the same or different.

A first spacing of a first print head to a first associated extraction device can have a first value, a second spacing of the first print head from a second associated extraction device can have a second value, a third spacing of a second print head from a third associated extraction device can have a third value, and a fourth spacing of the second print head from a fourth associated extraction device can have a fourth value. The first and second values can be the same or different. The third and the fourth value can be the same or different. The first, second, third, and fourth values can be the same or different.

A printing plane can be defined in that it passes through the bottom edges, the top edges, or the center of at least one print head. In general, the printing planes run perpendicular to a longitudinal axis of the free space into which a container to be printed can be introduced. Printing in a printing plane does not necessarily mean linear printing along a peripheral line of the container, but, generally, two-dimensional planar printing along the outer surface of the container.

The at least one print head can be designed to apply printing ink to a container outer surface. The printing ink can generally be print media, such as a UV-hardening medium such as ink, paint, primer, varnish, prevarnish, lacquer, or the like. In general, UV radiation can be used in a wavelength range of 200 to 400 nm for UV hardening.

The print head can comprise a plurality of individually controllable nozzles which, for example, can be arranged in such a way that they can spray the printing ink inwards in the radial direction into the free space, and that they extend parallel to the longitudinal axis of the free space so that when the container to be printed is rotated around the longitudinal axis, the ink can be applied over the entire surface along the circumferential direction of the container. The nozzles can be operated, for example, by means of a piezoelectric control.

If the device for printing containers comprises more than one printing plane, it can be provided that a partial printing image be able to be applied to the outer surface of the container in each of these printing planes. For example, the rotation of the container to be printed about its longitudinal axis can also be superimposed on a linear movement along the longitudinal axis, whereby process time can be saved.

Two, three, four, five, or more print heads can be arranged In each of the at least one printing plane. When several print heads are provided in a printing plane, a number of different inks corresponding to the number of print heads can be applied to a container in this printing plane, for example. For example, if five print heads are provided, the five colors, magenta, cyan, yellow, white, and black (key), can each be provided by one of the print heads. It may also be provided that several print heads provide a first color in a printing plane, so that the container to be printed must be rotated by a smaller angle than if there were only one print head providing this first color, in order to apply a partial image in the first ink on the outer surface of the container.

It can be provided that the printing device may comprise a total of six or eight print heads in two printing planes, wherein one or two extraction devices can be associated with each print head.

For carrying out a printing process, one line connection or several line connections of the print heads (depending upon printing ink to be printed) to respective printing ink reservoirs can be provided. The line connections and/or the printing ink reservoirs do not need to be part of the printing device, but can be part of the printing device and be enclosed by it.

The printing device according to the disclosure therefore provides a spacing along the outer circumference between the at least one print head and the at least one extraction device associated therewith. This can improve the extraction of the printing mist—for example, also by protecting the extraction device.

The spacing can lie within a range of 0.1 millimeters to 10 millimeters. The spacing can create a volume region through which air can enter, wherein the entering air can, for example, be at least partially extracted together with the printing mist. This air can surround the printing mist, for example, like an air cushion. For example, the Venturi effect can be utilized.

The spacing can allow air to pass through so that air which flows through the spacing (a volume area which can be formed by the spaced arrangement) can be extracted by the extraction device.

The extraction device can comprise an extraction tube, an extraction nozzle, and a connection device. For carrying out an extraction process, a device generating a controllable and/or regulatable extraction pressure can be connected to the extraction tube. This device does not need to be part of the printing device, but can be part of the printing device and included by it.

For example, the extraction tube can be arranged on the connection device, and the connection device can be provided for a connection to the extraction nozzle. The extraction tube and the connection device can therefore remain in the printing device, for example, when the extraction nozzle is replaced.

The extraction nozzle can be designed to be replaceable. A replacement of a complete extraction device can therefore be avoided. The extraction nozzle can have a fixed but releasable connection to the connection device which can be releasable by a human operator—for example, without mechanical aids. For example, a connection can be provided using the click system.

A replacement tool can be provided for replacing the suction nozzle. The replacement tool can be introduced into the free space of the printing device and pushed over the extraction nozzle. The replacement tool and suction nozzle can be connected by engaging snap-in elements of the replacement tool in through-holes in the suction nozzle. This makes it easy for the extraction nozzle to be removed from the connecting device—for example, by a human operator. For pulling off the extraction nozzle from the connection device, the replacement tool can also comprise a bent edge. The bent edge can make it easier for a human operator to handle the replacement tool.

The extraction nozzle can comprise a plug-in connection that can be at least partially received by the connection device. The extraction nozzle can also comprise more than one plug-in connection which can be received by the connection device. Depending upon the length of the plug-in connection or the plug-in connections, the connection device can comprise a depression or depressions, or a through-hole or through-holes for receiving.

At least in a first region, the extraction nozzle can comprise a magnetic metal, and the connection device can comprise a magnet in a second region, whereby a connection of the extraction nozzle to the connection device can be achievable.

The extraction nozzle can be in at least two parts. The at least two-part design can be provided in order to enable cleaning of the extraction nozzle after it has been removed from a printing device. For this purpose, the at least two parts of the extraction nozzle can be fixedly, but releasably, connected.

For example, a first part can be provided as a plate, and a second part with three-dimensional structures. The first part can comprise bores for receiving screws, wherein the screws can be screwed into threaded bores of the second part in order to connect the first part and the second part to one another. Before connecting the two parts, a seal can be arranged between the two parts (which can leave the slot of the extraction nozzle free) to prevent the passage of extracted printing mist and/or extracted air through the extraction device during an extraction process.

The second part can comprise the plug-in connection and the outlet and be designed to be bulbous, so that an inner space of the extraction nozzle can be formed after the two parts have been connected. The inner space may comprise an inner surface, wherein the inner surface may be both on the first and on the second part. In this case, a surface of the inner space can be regarded as the inner surface that can be contacted by the extracted printing mist and/or extracted air during the extraction process.

An inner surface of the extraction nozzle can comprise a coating. For example, a coating can be provided for an extraction nozzle made of metal and/or light metal and can be baked into the material of the suction nozzle and therefore have good adhesion.

For example, a fluoropolymer-based coating can be provided. These can have good anti-adhesion properties, sliding properties, and high chemical resistance.

It can be useful to coat the inner surface of the extraction nozzle, so that any printing mist deposited there can be quickly extracted in the direction of the outlet and extraction tube. The coating can also ensure that accumulated printing mist, which has been dried by a UV drying device for example, can be removed more easily when the suction nozzle is cleaned.

Coating may not be necessary in the extraction tube, for example, since the accumulated printing mist cannot harden there because the UV drying device has no effect there.

For example, at least a portion of an outer surface of the extraction nozzle can comprise a coating. The foregoing can apply to the coating. For example, a region that surrounds the slot of the extraction nozzle can comprise a coating. This can be useful, for example, if there is an unexpected build-up of printing mist in this region.

The extraction nozzle can comprise a plastic and/or a metal and/or a light metal. For example, the extraction tube and/or the connection device can comprise the same plastic and/or the same metal and/or the same metal as the extraction nozzle, or a different plastic and/or metal and/or light metal. The extraction nozzle and/or the extraction tube and/or the connection device can be produced, for example, by means of 3-D printing.

The extraction nozzle can comprise a slot, running parallel to a longitudinal axis of the free space, as an access to an inner space of the extraction nozzle, wherein the inner space can comprise an outlet to the extraction tube. The slot can have a length and a width and, for example, constitute an access to the inner space of the extraction nozzle. The length of the slot can be dimensioned such that it can extend centrally over an overall height of the extraction nozzle.

A height of the inner space can decrease towards the outlet. It can be possible to reduce the height of the inner space, since the particle flow can be centered when the printing mist is extracted, which can also reduce its expansion range. It is therefore not absolutely necessary to maintain an initial height of the inner space (which can be equal to a length of the slot, for example) up to the outlet.

For example, the outlet can be provided in or adjacent to a bottom region of the extraction nozzle. A bottom region of the extraction nozzle can be designed in such a way that it can form an angle with a printing plane, in which the associated print head can be arranged, so that printing mist accumulated in the inner space, as long as it is liquid, can reach the outlet under the effect of gravity (and the extraction pressure). In addition, it can be avoided that accumulated liquid printing mist (i.e., for example, ink or the like) be able to run out of the slot.

If exactly one of the extraction devices is assigned to one of the print heads in each case, the exactly one extraction device can be arranged on a first side or on a second side of the print head with the spacing. A side in this case can be a side of the print head which runs parallel to the longitudinal axis of the free space and can run substantially radially.

For example, the extraction nozzle can be located in the direction of rotation of the container to be printed.

If exactly two of the extraction devices are assigned to one of the print heads in each case, one of the two extraction devices can be arranged on a first side and the other of the two suction devices on a second side of the print head with the spacing.

An extraction device for extracting printing mist is provided for use in the printing device, as described above or further below, wherein the extraction device comprises an extraction tube, an extraction nozzle, and a connection device.

The extraction tube can be arranged on the connection device, and the connection device can be provided for a connection to the extraction nozzle.

The extraction nozzle can comprise a plug-in connection that can be at least partially received by the connection device.

At least in a first region, the extraction nozzle can comprise a magnetic metal, and the connection device can comprise a magnet in a second region, whereby a connection of the extraction nozzle to the connection device can be achievable.

The extraction nozzle can be in at least two parts.

An inner surface of the extraction nozzle can comprise a coating, wherein, for example, at least a portion of an outer surface of the extraction nozzle can comprise a coating.

The extraction nozzle can comprise a plastic and/or a metal and/or a light metal.

The extraction nozzle can comprise a slot as an access to an inner space of the extraction nozzle, wherein the inner space can comprise an outlet to the extraction tube.

A height of the inner space can decrease towards the outlet, wherein, for example, the outlet can be provided in or adjacent to a base region of the extraction nozzle.

### BRIEF DESCRIPTION OF THE FIGURES

The accompanying figures show, by way of example, aspects and/or exemplary embodiments of the disclosure for better understanding and illustration. In the figures:

FIG. 1A shows an oblique view from above of a printing device,

FIG. 1B shows an enlarged detail from FIG. 1A,

FIG. 2 shows a plan view of a printing cage of a first embodiment of the printing device,

FIG. 3A shows a print head with an extraction device in a first printing plane and a print head with a removed extraction nozzle in a second printing plane,

FIG. 3B shows an enlarged detail of the print head with the removed extraction nozzle from FIG. 3A,

FIG. 4A shows a print head with an extraction device and a replacement tool arranged at the extraction nozzle,

FIG. 4B shows the print head with the extraction nozzle removed by the replacement tool,

FIG. 5 shows an oblique view of individual parts, which are encompassed by the extraction nozzle,

FIG. 6 shows a side view of the print head with an extraction device which comprises a two-part extraction nozzle,

FIG. 7A shows an oblique view from the front of an arrangement of a print head and an extraction nozzle of the prior art,

FIG. 7B shows an oblique view from above of the arrangement of FIG. 7A,

FIG. 8A shows an oblique view from the front of a first arrangement of a print head and an extraction nozzle,

FIG. 8B shows an oblique view from above of the first arrangement of FIG. 8A,

FIG. 9A shows an oblique view from the front of a second arrangement of a print head and an extraction nozzle,

FIG. 9B shows an oblique view from above of the arrangement of FIG. 9A,

FIG. 10A shows a first view of traces of particles of the printing mist for the arrangement of FIGS. 7A, 7B,

FIG. 10B shows a first view of traces of particles of the printing mist for the arrangement of FIGS. 8A, 8B

FIG. 10C shows a first view of traces of particles of the printing mist for the arrangement of FIGS. 9A, 9B,

FIG. 11A shows a second view of traces of particles of the printing mist for the arrangement of FIGS. 7A, 7B,

FIG. 11B shows a second view of traces of particles of the printing mist for the arrangement of FIGS. 8A, 8B, and

FIG. 11C shows a second view of traces of particles of the printing mist for the arrangement of FIGS. 9A, 9B.

### DETAILED DESCRIPTION OF THE FIGURES

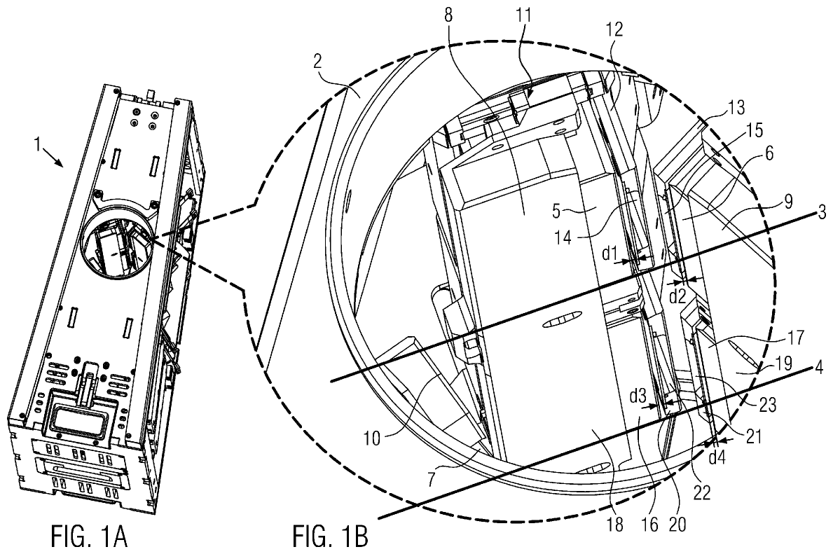

FIG. 1A shows an oblique view from above of a printing device 1 for printing containers, such as bottles or cans.

FIG. 1B shows an enlarged detail of FIG. 1A. In a printing cage 2, several print heads and extraction devices are arranged in a first printing plane 3 and in a second printing plane 4 along an outer circumference of a free space, which print heads are designed to receive a container to be printed, which can be partially seen in the illustration.

In the first printing plane 3, three print heads 5, 6, 7 can be seen, each of which is associated with a shutter 8, 9, 10. The shutters 8, 9, 10 can cover print nozzles of the print heads 5, 6, 7 if no printing ink is applied by them. The shutters 8, 9, 10 are each designed to be movable by means of a movement mechanism 11 so that they can be brought from a covering position into a release position of the print nozzles. In this case, the shutters 8, 9, 10 can be moved from the covering position to a first side of a print head 5, 6, 7 or to a second side of the print head 5, 6, 7 and therefore release the nozzles in the release position to discharge printing ink. In the illustration, the shutter 10 of the one print head 7 can be moved in a direction to the top left, the shutter 8 of the one print head 5 can be moved in a direction to the left, and the shutter 9 of the one print head 6 can be moved in a direction to the right in order to go from the covering position to the release position. The movements when moving from the release position to the covering position are correspondingly opposite.

An extraction device 12, 13 for extracting printing mist is associated with each of the print heads 5, 6, 7, wherein only two of them are visible in the illustration. The print heads 5, 6 and the extraction devices 12, 13 associated therewith are each at a spacing d1, d2 from one another along the outer circumference.

In the second printing plane 4, two of the print heads 16, 17 can be seen, each of which is assigned a shutter 18, 19. The shutters 18, 19 can cover print nozzles of the print heads 16, 17 if no printing ink is applied by them. The shutters 18, 19 are also each designed to be movable by means of a movement mechanism (not visible), so that they can be brought from a covering position into a release position of the print nozzles. In the illustration, the shutter 18 of the one print head 16 can be moved in a direction to the left, and the shutter 19 of the one print head 17 can be moved in a direction to the right in order to reach the release position from the covering position. The movements when moving from the release position to the covering position are correspondingly opposite.

A extraction device 20, 21 for extracting printing mist is associated with each of the print heads 16, 17. The print heads 16, 17 and the extraction devices 20, 21 associated therewith each are at a spacing d3, d4 from one another along the outer circumference.

Refer to the description above for general information on understanding a print layer.

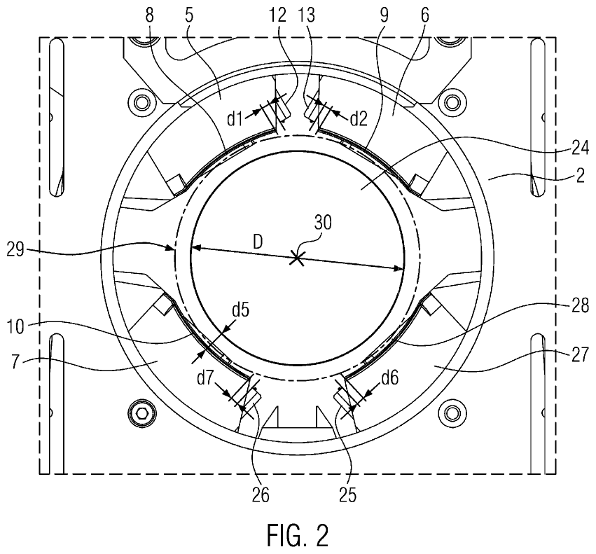

FIG. 2 is a plan view of a printing cage 2 of a first embodiment of the printing device 1. The four print heads 5, 6, 7, 27 arranged in the first printing plane 3 along the outer circumference of the free space 29 can be seen with the shutters 8, 9, 10, 28, which are each in the release position in the illustration. A container 24 to be printed with a diameter D is arranged in the free space 29 and is at a spacing d5 from the print heads (5, 6, 7, 27) in the release position.

The extraction device 12 associated with the first print head 5, which are at the first spacing d1 from one another, is arranged on the right side of the print head 5 (in an imaginary view from the longitudinal axis 30 of the printing device 1 in the direction of the outer circumference).

The extraction device 13 associated with the second print head 6, which are at the second spacing d2 from one another, is arranged on the left side of the print head 6.

The extraction device 25 associated with the third print head 27, which are at the third spacing d6 from one another, is arranged on the right side of the print head 27.

The extraction device 26 associated with the fourth print head 7, which are at the fourth spacing d7 from one another, is arranged on the left side of the print head 7.

The arrangement of the extraction devices 12, 13, 25, 26 on different sides of the print head results, as already mentioned, from the movement of the shutters 8, 9, 10, 28, which in the release position may not cover the extraction devices 12, 13, 25, 26, since these would otherwise not be usable for the extraction of printing mist.

The expressions, “first,” “second,” “third,” “fourth,” and their derivatives serve here and in other parts of the application merely for distinguishing otherwise identical expressions if no contrary information is given, and otherwise have no further restrictive meaning.

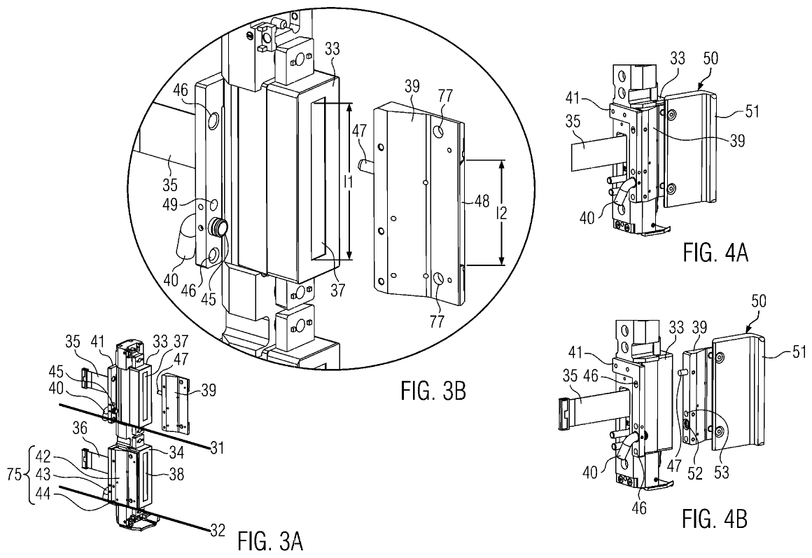

FIG. 3A shows a first print head 33 with a first extraction nozzle 39 removed in a first printing plane 31 and a second print head 34 with an extraction device 75 in a second printing plane 32. For the sake of clarity, the shutters of the print heads have been omitted in the illustration.

The first print head 33 comprises first print nozzles 37, the arrangement area of which is schematically identified by a rectangle. The first print head 33 can be controlled by means of a first control 35—for example, for discharging printing ink by means of individual or all print nozzles 37. The first extraction nozzle 39 has been pulled out of a first connection device 41—for example, in order to replace and/or clean it. The extraction nozzle 41 can be designed to be connectable to the connection device 41 by means of at least one plug-in connection 47. In the illustration, the first extraction tube 40 is still connected to the connection device 41, and a connecting piece 45 of the extraction tube passes through the connection device 41.

The extraction device 75 which is arranged on one side of the second print head 34 comprises a second extraction nozzle 42, a second connection device 44, and a second extraction tube 43. The second print head 34 comprises second print nozzles 38, the arrangement area of which is likewise schematically identified by a rectangle. The second print head 34 can be controlled by means of a second control 36—for example, for discharging printing ink by means of individual or all print nozzles 38.

FIG. 3B shows an enlarged detail of the first print head 33 with the removed first extraction nozzle 39 from FIG. 3A. Two bores 46 of the first connection device 41 can be seen, which are provided for receiving corresponding plug-in connections 47 (only one of which is shown) of the first extraction nozzle 39. The bores 46 are provided here as continuous bores; in other embodiments, the bores can be provided as depressions (with correspondingly designed plug-in connections of the extraction nozzle). The first connection device 41 also comprises a magnet 49 which, when the extraction nozzle 39 is attached, interacts with a magnetic metal of the first extraction nozzle 39 and can therefore ensure an ongoing connection of the extraction nozzle 39 and the connection device 41. The print nozzles 37 of the first print head 33 can extend over a first length l1. The slot 48 of the first extraction nozzle 39 can have a length l2. In the illustration, the first length l1 is greater than the second length l2.

Outside the region of the slot 48, the extraction nozzle 39 comprises two continuous bores 77, which can be provided, for example, for engaging a replacement tool (see FIGS. 4A and 4B).

FIG. 4A shows the first print head 33 with the first extraction device 76 and a replacement tool 50 arranged on the first extraction nozzle 39. The extraction device 76 comprises the first extraction nozzle 39 already described above, the first extraction tube 40, and the first connection device 41. The replacement tool 50 has been pushed over the extraction nozzle 39 and can be fixedly, but detachably, connected thereto by engaging in the continuous bores 77 (FIG. 3B). For pulling off the extraction nozzle 39 from the connection device 41, the replacement tool 50 can comprise a bent edge 51. The bent edge 51 can make it easier for a human operator to handle the replacement tool 50.

FIG. 4B shows the print head 33 with the extraction nozzle 39 removed by the replacement tool 50. The magnetic metal 53 can be seen on the extraction nozzle 39 and interacts with the magnet 49 of the connection device 41 when the extraction nozzle 39 is attached, and can therefore ensure an ongoing connection of the extraction nozzle 39 and the connection device 41. In addition, an outlet 52 can be seen in the extraction nozzle 39, in which the connecting piece 45 of the extraction tube 40 can be received when the extraction nozzle 39 is attached. The outlet 52 is arranged in or adjacent to a bottom region of the extraction nozzle 39.

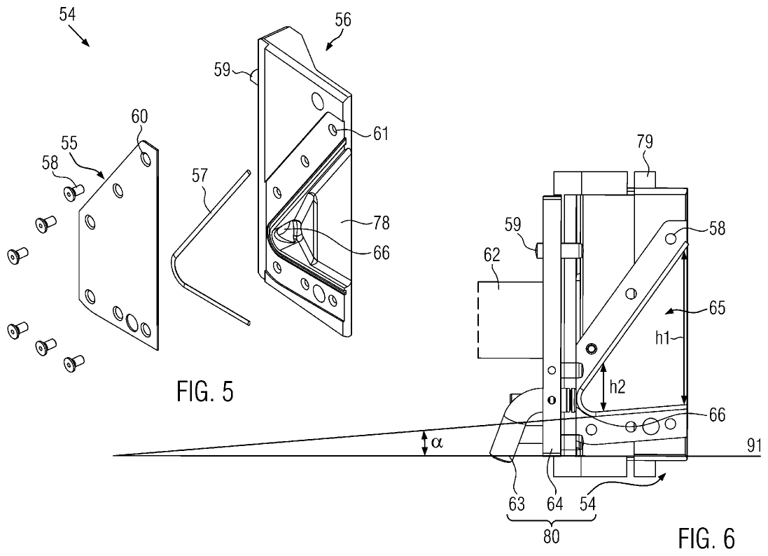

FIG. 5 shows an oblique view of individual parts which are encompassed by the extraction nozzle 54. In this case, the extraction nozzle 54 is essentially constructed in two parts, wherein a first part 55 is provided as a plate and a second part 56 with three-dimensional structures. The first part 55 comprises bores 60 for receiving screws 58 which can be screwed into threaded bores 61 of the second part 56 in order to connect the first part 55 and the second part 56. Before the two parts 55, 56 are connected, a seal 57 can be arranged between the two parts 55, 56 (which leaves the slot of the extraction nozzle 54 free) to prevent the passage of extracted printing mist and/or extracted air through the extraction device during an extraction process.

The second part 56 can comprise the plug-in connection 59 and the outlet 66 and be designed to be bulbous so that an inner space can be formed after the two parts 55, 56 have been connected. An inner surface 78 of the second part is indicated in FIG. 5. In this case, a surface of the inner space is regarded as the inner surface 78 that can be contacted by extracted printing mist and/or extracted air during the extraction process. The first part 55 can accordingly also comprise an inner surface.

FIG. 6 shows a side view of a print head 79 with an extraction device 80 which comprises the two-part extraction nozzle 54. The extraction device 80 also comprises the extraction tube 63 and the connection device 64. The extraction nozzle 54 has an inner space 65, wherein the height of the inner space decreases towards the outlet 66. In the region of the slot, a first height h1 of the inner space is greater than a second height h2 closer to the outlet 66. The first height h1 can be equal to a length of the slot, for example. A bottom region of the extraction nozzle 54 is designed such that it forms an angle α with a printing plane 91, in which the associated print head 79 can be arranged, so that printing mist accumulated in the inner space 65 can reach the outlet 66 under the effect of gravity and the extraction pressure, as long as it is liquid. The print head 79 can be controlled by means of a control 62—for example, for discharging printing ink by means of individual or all print nozzles of the print head 79.

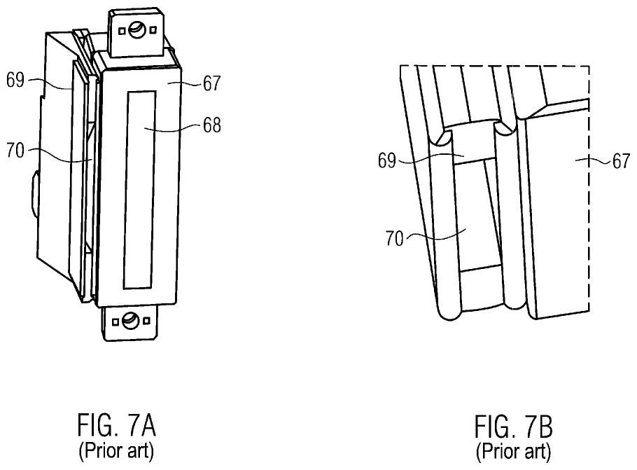

FIG. 7A shows an oblique view from the front of an arrangement of a print head 67 and an extraction nozzle 69 of the prior art. The print head 67 comprises print nozzles 68, the arrangement area of which is schematically identified by a rectangle. The extraction nozzle 69 comprises a slot 70 through which printing mist and/or air can be extracted. The extraction nozzle 69 is arranged without a spacing on one side of the print head 67. The shutter of the print head 67 has been omitted in the illustration for the sake of clarity.

FIG. 7B shows an oblique view from above of the arrangement of FIG. 7A.

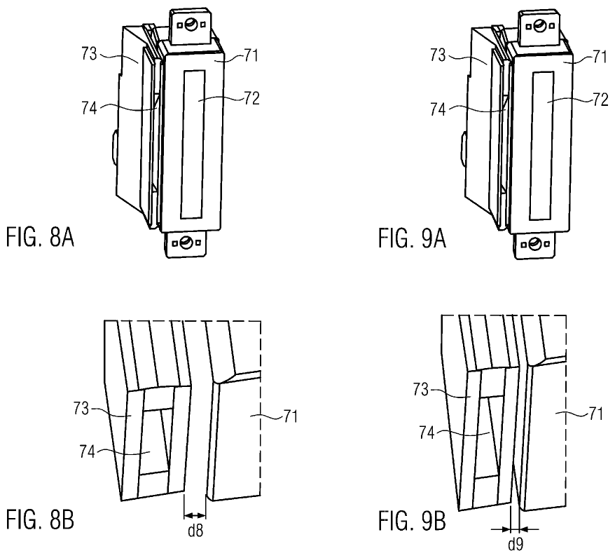

FIG. 8A shows an oblique view from the front of a first arrangement of a print head 71 and an extraction nozzle 73, which are at a first spacing d8 relative to one another which can be 2 mm, for example. The print head 71 comprises print nozzles 72, the arrangement area of which is schematically identified by a rectangle. The extraction nozzle 73 comprises a slot 74 through which printing mist and/or air can be extracted. The shutter of the print head 71 has been omitted in the illustration for the sake of clarity.

FIG. 8B shows an oblique view from above of the first arrangement of FIG. 8A.

FIG. 9A shows an oblique view from the front of a second arrangement of the print head 71 and the extraction nozzle 73, which are at a second spacing d9 relative to one another which can be 1 mm, for example.

FIG. 9B shows an oblique view from above of the arrangement of FIG. 9A.

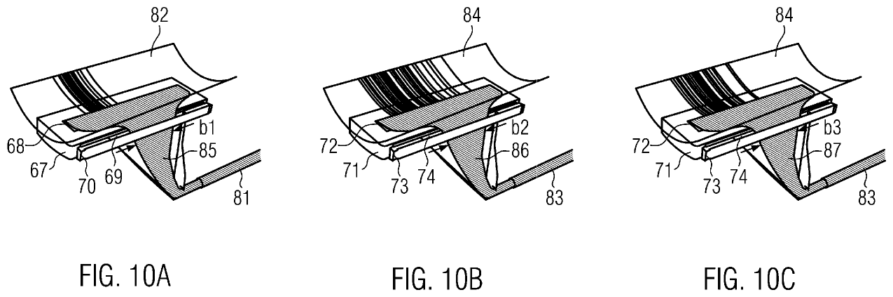

FIG. 10A shows a first view of traces of particles of the printing mist for the arrangement of FIGS. 7A, 7B, i.e., for the prior art. Printing ink can be discharged by the nozzles 68 of the print head 67 and impinge on a region 82 to be printed on an outer surface of a container. In this case, printing mist can arise which can comprise particles of various diameters and which can be extracted by means of the extraction device. The traces upon entering the extraction nozzle 70 through the slot 69, in the inner space of the extraction nozzle 70, and in the extraction tube 81 are indicated by the first hatched region 85.

FIG. 10B shows a first view of traces of particles of the printing mist for the arrangement of FIGS. 8A, 8B, i.e., at the first spacing d8 of the print head 71 and the extraction nozzle 73 of 2 mm. The traces of the particles that are contained in the printing mist and are extracted by the extraction device are indicated by the second hatched region 86 when entering the extraction nozzle 73 through the slot 74, in the inner space of the extraction nozzle 73, and in the extraction tube 83. Upon entry into the slot 74, the width b2 of the second hatched region 86 is smaller than the width b1 in the prior art that was shown in FIG. 10A. The same also applies in the inner space of the extraction nozzle 73.

FIG. 10C shows a first view of traces of particles of the printing mist for the arrangement of FIGS. 9A, 9B, i.e., at a spacing d9 of the print head 71 and the extraction nozzle 73 of 1 mm. The traces of the particles that are contained in the printing mist and are extracted by the extraction device are indicated by the third hatched region 87 when entering the extraction nozzle 73 through the slot 74, in the inner space of the extraction nozzle 73, and in the extraction tube 83. Upon entry into the slot 74, the width b3 of the third hatched region 87 is smaller than the width b1 in the prior art that was shown in FIG. 10A and somewhat wider than the width b2 at a spacing d8 of 2 mm that was shown in FIG. 10B.

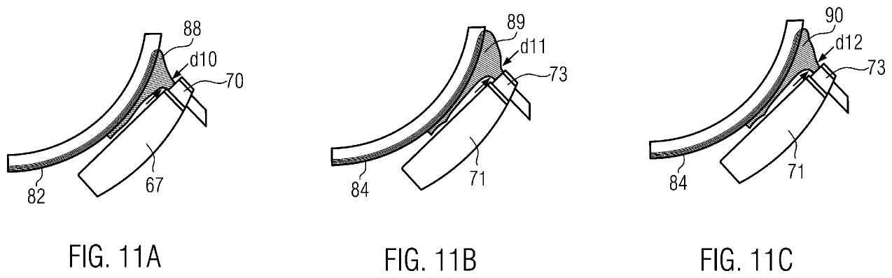

FIG. 11A shows a second view of traces of particles of the printing mist for the arrangement of FIGS. 7A, 7B with a viewing direction parallel to a longitudinal axis of a printing device. In this case, a thickness of a region occupied by the traces and a path upon entry into the slot of the extraction nozzle 70 can be discerned. The path of the traces is indicated overall by the hatched region 88. Upon entry into the slot of the extraction nozzle 70, the region 88 has a first thickness d10.

FIG. 11B shows a second view of traces of particles of the printing mist for the arrangement of FIGS. 8A, 8B with a viewing direction parallel to a longitudinal axis of the printing device. It can be seen that the thickness d11 of a region 89 which is assumed by the traces is smaller when entering the slot of the extraction nozzle 73 than the thickness d10 for the arrangement of the prior art. In addition, an angle of the region 89 when entering the slot is steeper and up to almost perpendicular, so that the traces do not run especially close to the edge of the extraction nozzle 73, but, rather, enter into the inner space of the extraction nozzle 73 through an air cushion.

FIG. 11C shows a second view of traces of particles of the printing mist for the arrangement of FIGS. 9A, 9B with a viewing direction parallel to a longitudinal axis of the printing device. Here too, it can be seen that the thickness d12 of a region 90 which is assumed by the traces is smaller when entering the slot of the extraction nozzle 73 than the thickness d10 for the arrangement of the prior art. In addition, an angle of the region when entering the slot is steeper and up to almost perpendicular, so that the traces do not run especially close to the edge of the extraction nozzle 73, but, rather, can enter into the inner space of the extraction nozzle 73 through an air cushion.

1. Printing device for printing containers, wherein the printing device comprises:
at least one printing plane, wherein at least one print head for applying ink to a container and at least one extraction device associated with the print head for extracting printing mist are arranged in each printing plane along an outer circumference of a free space which is designed to receive a container to be printed,
wherein the at least one print head and the at least one extraction device associated therewith are at a spacing from one another along the outer circumference.

2. Printing device according to claim 1, wherein the spacing is in a range of 0.1 millimeter to 10 millimeters.

3. Printing device according to claim 1, wherein the spacing allows air to pass through, so that air that flows through the spacing can be extracted by the at least one extraction device.

4. Printing device according to claim 1, wherein the at least one extraction device comprises an extraction tube, an extraction nozzle, and a connection device, wherein, for example, the extraction tube is arranged on the connection device, and the connection device is provided for a connection to the extraction nozzle.

5. Printing device according to claim 4, wherein the extraction nozzle is designed to be replaceable.

6. Printing device according to claim 4, wherein the extraction nozzle comprises a plug- in connection which is at least partially receivable by the connection device.

7. Printing device according to claim 4, wherein the extraction nozzle comprises a magnetic metal at least in a first region, and the connection device comprises a magnet in a second region, whereby a connection of the extraction nozzle to the connection device can be achieved.

8. Printing device according to claim 7, wherein the extraction nozzle is at least in two parts.

9. Printing device according to claim 8, wherein an inner surface of the extraction nozzle comprises a coating, wherein, for example, at least a portion of an outer surface of the extraction nozzle comprises a coating.

10. Printing device according to claim 9, wherein the extraction nozzle comprises a plastic and/or a metal and/or a light metal.

11. Printing device according to claim 10, wherein the extraction nozzle comprises a slot, running parallel to a longitudinal axis of the free space, as access to an inner space of the extraction nozzle, wherein the inner space comprises an outlet to the extraction tube.

12. Printing device according to claim 11, wherein a height of the inner space decreases towards the outlet, wherein, for example, the outlet is provided in or adjacent to a base region of the extraction nozzle.

13. Printing device according to claim 1, wherein, if exactly one of the at least one extraction device is assigned to one of the at least one print head in each case, the exactly one extraction device is arranged on a first side or on a second side of the one print head with the spacing.

14. Printing device according to claim 13, wherein, if exactly two of the at least one extraction device are assigned to one of the at least one print head in each case, one of the two extraction devices is arranged on a first side and the other of the two extraction devices on a second side of the one print head with the spacing.

15. Extraction device for extracting printing mist for use in the printing device according to claim 14, wherein the extraction device comprises:
an extraction tube, an extraction nozzle, and a connection device.

16. Extraction device according to claim 15, wherein the extraction tube is arranged on the connection device, and the connection device is provided for a connection to the extraction nozzle,
wherein, for example, the extraction nozzle comprises a plug-in connection which is at least partially receivable by the connection device,
wherein, for example, the extraction nozzle comprises a magnetic metal at least in a first region, and the connection device comprises a magnet in a second region, whereby a connection of the extraction nozzle to the connection device can be achieved,
wherein, for example, the extraction nozzle is at least in two parts,
wherein, for example, an inner surface of the extraction nozzle comprises a coating, wherein, for example, at least a portion of an outer surface of the extraction nozzle comprises a coating,
wherein, for example, the extraction nozzle comprises a plastic and/or a metal and/or a light metal,
wherein, for example, the extraction nozzle comprises a slot as access to an inner space of the extraction nozzle, wherein the inner space comprises an outlet to the extraction tube,
wherein, for example, a height of the inner space decreases towards the outlet, wherein, for example, the outlet is provided in or adjacent to a base region of the extraction nozzle.
